(19) United States
(12) Patent Application Publication
(10) Pub. No.: US 2018/0021106 A1
(43) Pub. Date: Jan. 25, 2018

(54) METHOD FOR PRODUCING A PRESTRESSED TOOTH REPOSITIONING DEVICE

(71) Applicant: ORTHO CAPS GMBH, Hamm (DE)

(72) Inventor: Wajeeh Khan, Hamm (DE)

(21) Appl. No.: 15/524,894

(22) PCT Filed: Nov. 6, 2015
(86) PCT No.: PCT/EP2015/075962

§ 371 Date: Oct. 11, 2017

(30) Foreign Application Priority Data
Nov. 7, 2014 (DE) 10 2014 116 247.1

(51) Int. Cl. A61C 7/08; A61C 5/00; A61C 7/28; A61C 7/00; A61C 7/14

(52) U.S. Cl. CPC A61C 7/08; A61C 7/002; A61C 7/146; A61C 7/28; A61C 5/007

(57) ABSTRACT

A method for producing a prestressed tooth repositioning device, comprising:
a) Producing a real or digital model of a jaw or jaw section of a patient with at least one misaligned tooth
b) Producing a real or digital model of a jaw or jaw section of a patient in which the position of at least one tooth is changed in comparison to the model mentioned in step a)
c) Digital or real positioning of a real or digital tooth repositioning device on the real or digital model mentioned in step b),
d) Transferring the real or digital tooth repositioning device according to step c) to the real or digital model with at least one misaligned tooth according to step a), with the real or digital tooth repositioning device being prestressed, and
e) Optionally, producing a real prestressed tooth positioning device on the basis of the digital tooth repositioning device according to step d) by way of a CAM method (FIG. 3B)

The invention relates to a method for producing a prestressed tooth repositioning device.

In conventional methods of orthodontics, combinations of brackets and wire arch elements are often used for repositioning misaligned teeth.

Here, the orthodontist attempts to reach the treatment goal step by step by further tensioning the arch wire element in an in-vivo situation on the patient. However, he could not be certain that the measures applied to the individual teeth would actually produce the desired result.

In addition, this method is associated with considerable time and effort for the therapist and patient, since the latter must come to the practice repeatedly for treatment.

It is a goal of the present invention to provide methods or devices that decrease the time and effort for therapist and patient.

An additional goal of the present invention is to supply methods or devices that improve the likelihood of success of an orthodontic treatment measure.

These and other tasks will be accomplished by the methods and devices according to the independent claims of the present invention. The dependent claims describe preferred embodiments. Ranges of values delimited by numerical values shall always comprise the said limit values.

### SUMMARY OF THE INVENTION

Before the invention is described in detail, it should be noted that this invention is not limited to certain components of the devices described or described production steps of the procedure, since these methods and devices can vary. It is also noted that the terminology for this is only being used purposely for certain described embodiments, and is not intentionally limited.

It should be noted that in the description used and in the dependent claims, the singular form such as “a” or “the” covers a singular and/or plural subject unless it is clearly worded differently in context. In addition it is to be agreed that when a. parameter range was given, the terminal numerical values serve as limiting values for the numerical range.

According to the invention a method for producing a prestressed (“pre-loaded”) tooth repositioning device is provided, which method has the following steps:
a) Producing a real or digital model of a jaw or jaw section of a patient with at least one misaligned tooth (“actual condition”)
b) Producing a real or digital model of a jaw or jaw section of a patient in which the position of at least one tooth is changed in comparison to the model mentioned in step a) (“target condition”),
c) Digital or real positioning of a real or digital tooth repositioning device on the real or digital model mentioned in step b),
d) Transferring the real or digital tooth repositioning device according to step c) to the real or digital model with at least one misaligned tooth according to step a), with the real or digital tooth repositioning device being prestressed, and
e) Optionally producing a real prestressed tooth positioning device on the basis of the digital tooth repositioning device according to step d) by way of a CAM method.

The terms “real” and “digital” as applied here in references to models and devices designate
real models, thus models that are touchable and can be processed using real methods, but can be transferred by suitable methods (3D scanning, stereoscopy or videoscopy) into the digital domain, or
virtual models consisting of digital data and only able to be processed on the computer (“Computer Aided Design,” CAD) but can be returned to the real domain by suitable manufacturing methods (Computer Aided Manufacturing,” CAM, or “Rapid Prototyping”)

When transferring the real or digital tooth repositioning device to the model with at least one misaligned tooth, the device is forced to undergo deformation and thus prestressed.

The term “prestressed,” as used here, designates the state of a repositioning device, which because of its forced deformation has a tendency to return to its starting position, and thus to transfer tilting and rotational moments relating to all six degrees of freedom to teeth.

It is preferably provided that the method further includes the step
f) Transferring the real or digital prestressed tooth repositioning device with the aid of a stress-conserving transfer template to the jaw or jaw section of a patient with at least one misaligned tooth

For example, the said stress-conserving template can have a curable liquid plastic which, after transfer of the tooth repositioning device appropriately to the model with at least one misaligned tooth, is applied to the tooth repositioning device prestressed in this manner and then cured.

After subsequent detachment of the tooth repositioning device, the latter remains in the cured, stress-conserving transfer template and can then be applied to the jaw or jaw section of the patient.

The said transfer is accomplished, for example, by affixing the attachment to the patient's teeth. The prestressed repositioning device now exhibits the tendency to return to its starting position. Since this corresponds to the state in which the position of at least one tooth is altered compared to the current state—and thus represents a target or transition state to be achieved clinically—the tilting and rotational moments affecting all six degrees of freedom transferred in this manner to the at least one tooth contribute to moving said tooth in the direction of the said target or transition state.

The production of a tooth repositioning device is considerably simplified with this method. in addition, the quality of treatment is also improved considerably, since the target or transition state is first defined on a model, and then this target or transition state of the tooth repositioning device is applied practically by prestressing the tooth repositioning device.

Thus the treatment goal can be achieved with a considerably higher likelihood of success than is the case with conventional methods, in which the orthopedist seeks to successively approach the treatment goal by subsequently tensioning the arch wire element in an in vivo situation on the patient, but cannot be certain that the measures performed on the individual teeth will actually have the desired result.

In addition, the time and effort for the therapist and patient is considerably reduced in s way, since the latter must come to the practice less frequently for treatment.

It is preferably provided that the tooth repositioning device as at least one arch wire element and at least two attachments.

Attachments is the tem applied in the following to devices which, applied to the surface of a tooth, can transfer the tilting and rotational moments exerted by an arch wire element to the said tooth.

In this simplest case this applies, for example, to attachments made of a curable plastic and applied directly to the teeth in situ using a suitable template. Here a wire or silicone tubing can be incorporated, which has the same cross section as the arch wire element and can be withdrawn after the plastic has cured. Alternatively, the said attachments may be brackets.

Brackets are common fastening elements for fixed-position apparatus in orthodontia. They are bonded to the surface of the tooth by special bonding techniques and thus form a purchase point for moving teeth using fixed apparatus. The characterizing feature of a bracket is the device for receiving the arch wire elements. This involves, for example, a horizontally positioned slit. Brackets may be distinguished according to where on the tooth they are fastened. If they are fastened on the outer surface facing the cheek, they are called buccal brackets. If they are on the inner surface facing the tongue, they are called lingual brackets. Brackets are often made of stainless steel, but may also be made of gold, ceramic, composite or titanium. An important property that may be of partially decisive importance for selecting the bracket and arch material is its friction. Both the material combination of bracket and arch and the type of the ligatures used may increase or reduce the friction.

In the following, the term arch wire elements is applied to devices that are disposed on the attachments and transfer corrective forces to them. Such arch wire elements are preferably wires that can be introduced into the recesses of the attachments and shaped therein as necessary. They may be made of steel and comparable materials, but also of shape memory materials such as Nitinol or NiTiCu.

The elastic restoring tendency of the wire arch element, by way of the attachments, applies a force to the tooth, resulting in the fact that the tissue in the periodontal space is compressed at some points (compression zone) and stretched at the respective opposite zone (tensile zone). This stimulates the occurrence of remodeling processes, in which osteoclasts break down bone in the compression zone and osteoblasts build it up in the tensile zone.

The pre-stress produced may also eliminate the “sliding mechanics” occurring in the case of conventional methods, which are enabled by the fact that the arch wire element is slidingly fastened to the attachments, which can therefore move relative to one another. As a result of the prestressing, the arch wire elements can be solidly affixed on the attachments. This also enables, if desired, arrangements in which only two attachments are used, namely one on the tooth to be corrected and one on an adjacent tooth, which serves as an anchor.

The said arch wire element is preferably a spring element, an arch wire or a partial wire (which thus does not cover the entire jaw, hut only sections thereof, which will not be shown in greater detail in the following

It is preferably provided that the arch wire element consists of a wire with a polygonal cross section. It is also preferably provided that at least one attachment has a polygonal bore or recess.

In this embodiment, the arch wire element can be introduced into the bore or recess of the attachment by press fit. In this manner attachments and arch wire elements can transfer tilting and rotational moments relating to all six degrees of freedom to one another.

It is preferably provided that at least one attachment has a ligature with a lock into which the arch wire element can be introduced.

Preferably it is also provided that the digital or real positioning of a real or digital tooth repositioning device takes place on the real or digital model mentioned in step b), wherein
at least two attachments are disposed on at least two teeth of the model and then an arch wire element is introduced into correspondingly shaped bores or recesses of the attachment, or
an already prefabricated combination of at least two attachments with an arch wire element already introduced into them is affixed to the at least two teeth.
in situ an attachment, having a bore or recess for the arch wire element, is produced on at least one tooth of the model, and then an arch wire element is introduced into correspondingly shaped bores or recesses of the attachment, or

In the in situ production of attachments this can be done, for example, with the aid of a suitable template directly on the tooth models, and for example may consist of a curable plastic. Here a wire or silicone tubing can be incorporated, which has the same cross section as the arch wire element and can be withdrawn after the plastic has cured.

Preferably it is also provided that the real model of the jaw or jaw section with at least one misaligned tooth (“actual state”) is produced by taking an impression in dental impression compound and then casting the same with dental casting compound.

Dental impression compound, for example, has a high alginate fraction and is used for producing a negative model of a jaw or jaw section. Dental casting compound, for example, contains a high fraction of plaster and is used for producing a positive model of a jaw or jaw section by pouring into the previously produced negative model

Preferably it is also provided that the digital model of the jaw or jaw section with at least one misaligned tooth (“actual state”) is produced by a three-dimensional imaging method.

This can be accomplished, for example, by 3D scanning, stereoscopy or probe-based scanning of the real model of the jaw or jaw section with at least one misaligned tooth, or by in vivo videoscopy or intraoral of the jaw or jaw section with at least one misaligned tooth.

Corresponding methods are disclosed, for example, in Hemayed 1996, Biggerstaff 1970, Kuroda 1996 or Ender 2013.

In addition it is then possible using the CAM method described, also based on this step, to produce a real model of the jaw or jaw section with at least one misaligned tooth.

Methods that may be considered, for example, are stereolithography, CNC milling or 3D plotting.

It is also preferably provided that the real model of the jaw or jaw section in which the position of at least one tooth has been modified (“target condition”) is produced by sawing off the said tooth and placing it on a socket of a deformable material, and then manually manipulating the position of the said tooth.

Corresponding methods are disclosed, for example, in McNamara 1996 or U.S. Pat. No. 2,467,432.

It is also preferably provided that the digital model of the jaw or jaw section in which the position of at least one tooth has been modified (“target condition”) is produced by digital manipulation of the data set representing the jaw or jaw section.

In addition it is then possible using the CAM method described, also based on this step, to produce a real model of the jaw or jaw section with at least one misaligned tooth.

Furthermore according to the invention a prestressed tooth repositioning device, produced with a method according to the above description, is also provided.

It is also preferably provided that the said tooth repositioning device has at least two attachments and one arch wire element.

Furthermore according to the invention the use of a prestressed tooth repositioning device according to the above description for treating dental misalignment in patients is envisaged.

Furthermore according to the invention a tension-conserving transfer template for transferring a prestressed digital tooth repositioning device to the jaw or jaw section of a. patient with at least one misaligned tooth is envisaged.

In addition, according to the invention a kit for correcting dental misalignment, having
a) a combination of at least two attachments with an arch wire element already arranged therein, wherein the said combination is arranged in the area of a jaw section of a patient having at least one misaligned tooth (“actual state”) and
b) at least one dental splint made of a resilient material, wherein the said dental splint is arranged in at least one area of the patient's jaw section located outside of the area mentioned under a

The term “resilient material” as used here designates an elastically deformable material, which however builds up restoring forces upon deformation. Acrylate materials are preferably used in this process.

It is preferably provided that the combination of at least two attachments and one wire arch element is produced with the above described method.

Furthermore it is preferably provided that the dental splint consisting of a resilient material is an aligner, retainer or positioner.

The terms aligner, retainer and positioner will be used synonymously here, and designate removable dental correction devices that are used in orthodontic treatment and have recesses for at least one tooth. They are able to stabilize the position of teeth (for example following orthodontic treatment with a combination of attachments and arch wire element) or actively correct the position of teeth. They consist of resilient material and are often transparent.

In the said kit, the combination of attachment and arch wire element on one hand and the dental splint on the other hand is synergistic.

Preferably it is further provided that the at least one dental splint has a recess in the area of the combination of attachment and arch wire element.

The dental splint is used for stabilizing the additional teeth in the patient's jaw and may optionally also have a repositioning effect on individual teeth, for which the need for correction may be less than in reference to the tooth corrected by the combination of attachment and arch wire element.

Here the dental splint also serves for stabilizing the teeth surrounding the tooth to be corrected, to which the combination of attachment and arch wire element is fastened, and which serve as abutments for these teeth. In this way the dental splint prevents the position of teeth surrounding the tooth to be corrected from shifting, and thus guarantees an adequate differential movement of the tooth to be corrected.

The combination of attachment and arch wire element on one hand and dental splint on the other hand makes it possible, by stabilizing the teeth that serve as abutments for the tooth to be corrected, to reduce the number of the said teeth serving as abutments.

In the extreme case only a single adjacent tooth may serve as an abutment. This is especially possible in that the “sliding mechanics” that occur in the case of conventional methods may be eliminated. Therefore the arch wire element can be solidly affixed on the attachments. This also enables, if desired, arrangements in which only two attachments are used, namely one on the tooth to be corrected and one on an adjacent tooth, which serves as an anchor.

Preferably it is further provided that the at least one dental splint has an enlargement in the area of the combination of attachment and arch wire element.

The dental splint serves to stabilize the additional teeth in the patient's jaw and optionally may also have a repositioning effect on individual teeth, the need for correction of which is less than with regard to the tooth corrected by the combination of attachment and arch wire element.

In this process the dental splint may also consist of a series of incremental dental splints, which have successive repositioning effects on additional teeth in the patient's jaw. In this manner the volume of the expansion in the area of the tooth corrected by the combination of attachment and arch wire element decreases successively.

In both cases the one or more dental splints may be designed such that through the combination of attachment and arch wire element they support the correction pathway of the tooth to be corrected.

Preferably it is further provided that the at least one dental splint in the area of at least one attachment has an enlargement in which the bracket may be received by press fit.

In this way the attachments can also serve as anchoring and force transfer points for dental splint.

Furthermore it is preferably provided that the said kit has several dental splints consisting of a resilient material, wherein at least
one dental splint has a geometry selected to support the repositioning of at least one misaligned tooth from the actual state into a transition state, accomplished by the combination of attachment and arch wire element,
and one dental splint has a geometry selected to support the repositioning of the at least one misaligned tooth from the transition state to a target state, accomplished by the combination of attachment and arch wire element.

In addition, further incremental dental splints nay be provided, having a geometry selected to support the repositioning of at least one misaligned tooth from a first transition state into a second transition state (and optionally further transition states as well), accomplished by the combination of attachment and arch wire element

Such incremental dental splints are disclosed, for example, in the EP patent EP2263598 B1 and EP patent EP1369091 B1, the full contents of which are referenced here and the contents of which are included by reference in the disclosure content of the present application produced here.

Furthermore the use of a kit according to the above description for treating dental misalignment in patients is envisaged.

Furthermore it is preferably provided that for successive treatment of dental misalignment, several dental splints consisting of a resilient material, are used, wherein at least
one dental splint has a geometry selected to support the repositioning of at least one misaligned tooth from the actual state into a transition state, accomplished by the combination of attachment and arch wire element,
and one dental splint has a geometry selected to support the repositioning of the at least one misaligned tooth from the transition state to a target state, accomplished by the combination of attachment and arch wire element.

In addition, further incremental dental splints nay be provided, having a geometry selected to support the repositioning of at least one misaligned tooth from a first transition state into a second transition state (and optionally further transition states as well), accomplished by the combination of attachment and arch wire element

### DRAWINGS AND EXAMPLES

The present invention will be explained in further detail using the figures and examples presented in the following. It should be noted that the figures and examples are only descriptive in nature and are not intended to limit the invention in any way,

FIG. 1A shows a dental arch of a patient with misaligned teeth 11, 12, 13 and the tongue 14.

FIG. 1B shows a reproduction 15 of this dental arch in plaster, produced for example by creating an impression of the dental arch according to FIG. 1A in a dental impression compound and then casting it with a plaster material.

Alternatively the reproduction of the dental arch can also be produced using an alveolar ridge model as disclosed in WO2014096341 from the present applicant, the full contents of which are referenced here and the contents of which are included by reference in the disclosure content of the present application.

FIG. 1C shows a setup 16, which is produced starting from the reproduction of the dental arch with misaligned teeth according to FIG. 1B and shows the final state of the dental configuration—or a transition state thereof—to be produced clinically.

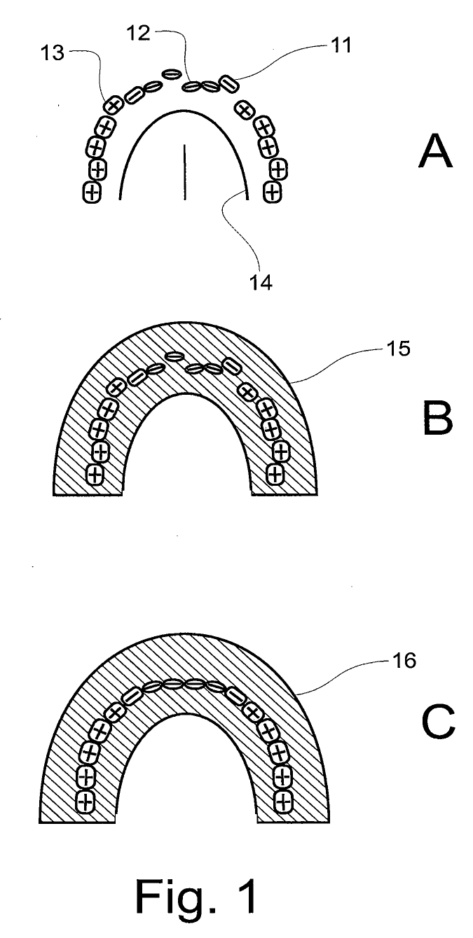

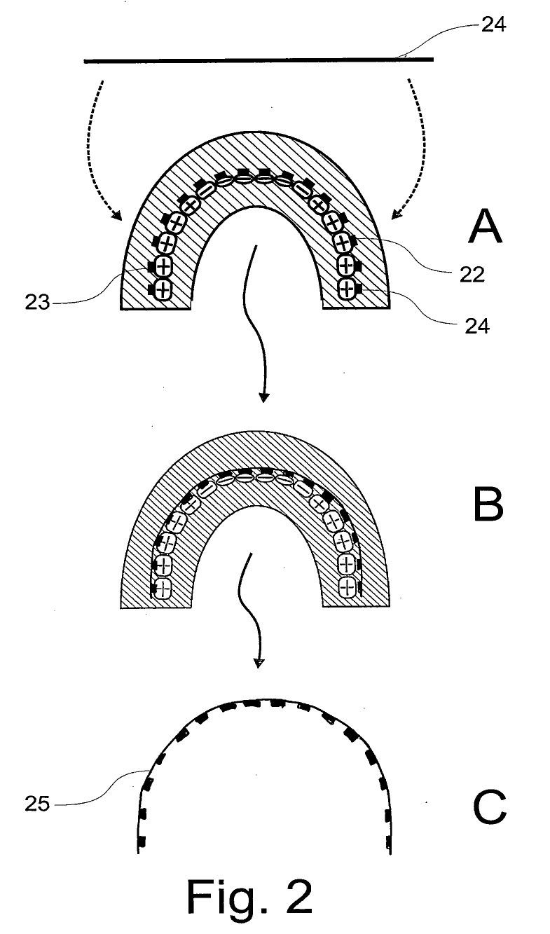

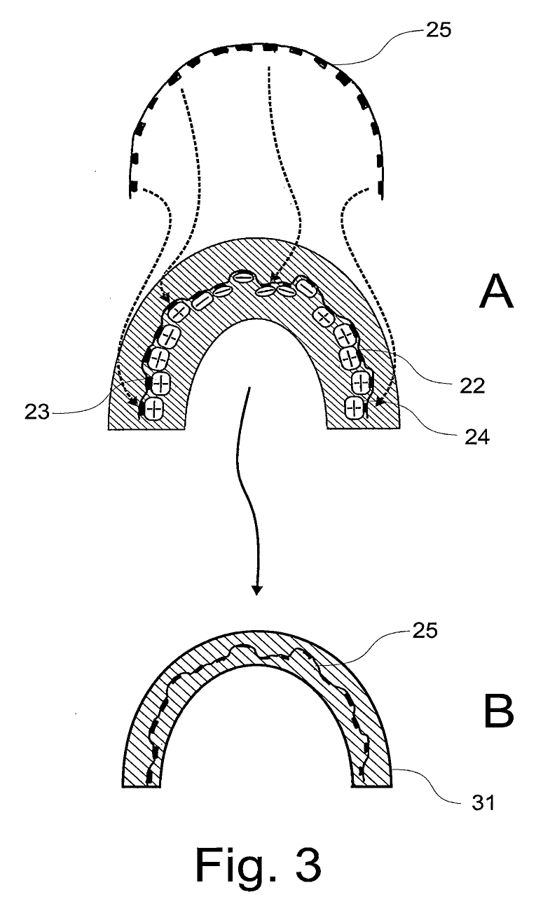

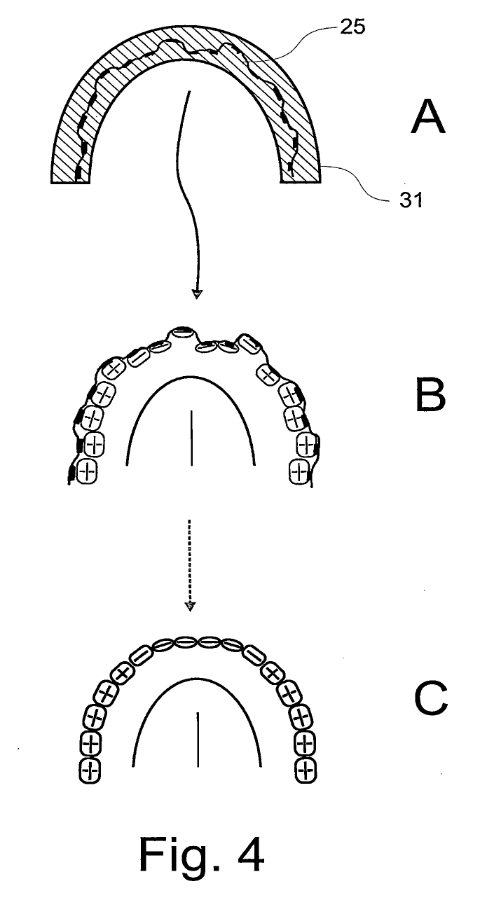

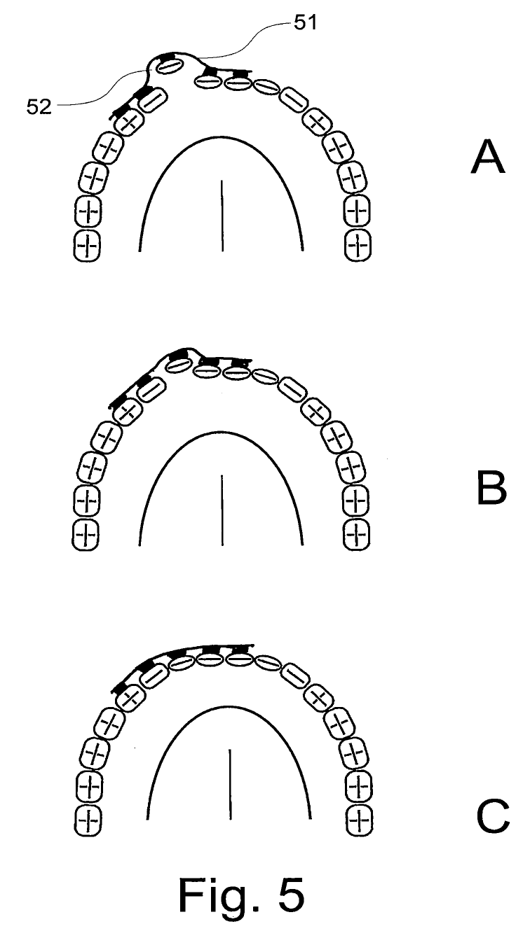

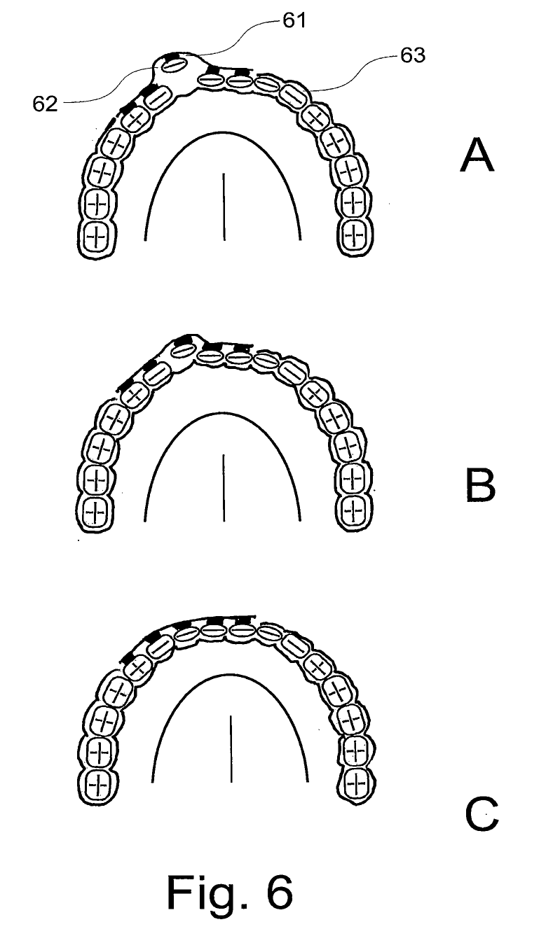

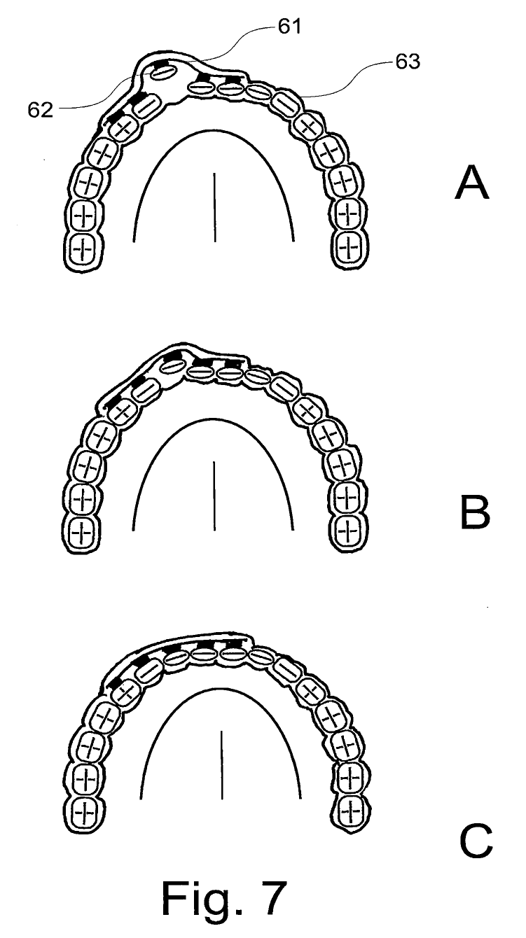

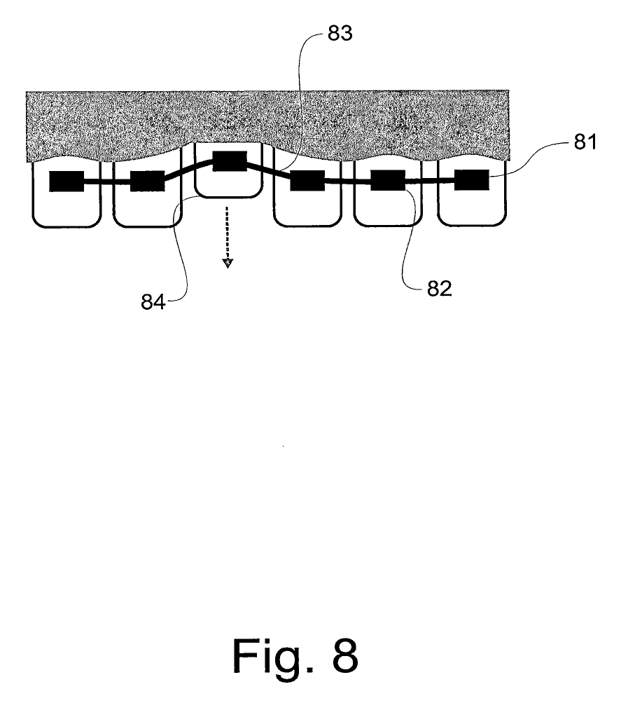

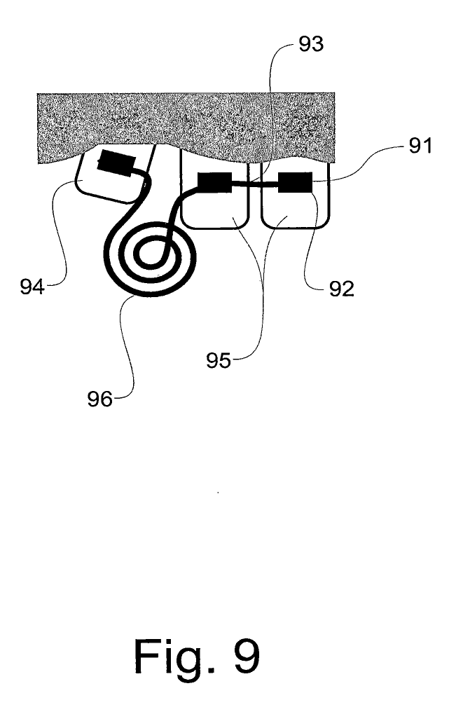

The setup in FIG. 1C can be produced, for example, by removing the misaligned dental model from the reproduction of the dental arch according to FIG. 1B, placing it in a wax socket, reinserting it into the dental arch, and manipulating it into position after heating the wax.

Alternatively, this setup can also be produced by a so-called CAD/CAM method. In this, the reproduction of the dental arch with misaligned teeth according to FIG. 1B is scanned in using a 3-D scanner. The subsequent manipulation step for repositioning the misaligned dental model is performed digitally with the aid of a suitable software program, after which, finally with the aid of a CAM procedure, for example using a 3-D printer or a milling machine, the setup with the repositioned tooth models is produced. Methods of this type are disclosed, for example, in the EP patent EP2263598 B1, the full contents of which are referenced here and the contents of which are included by reference in the disclosure content of the present application.

Alternatively, this setup can also he produced by a so-called CAD/CAM method. In this, the reproduction of the dental arch with misaligned teeth according to FIG. 1B is scanned in using a 3-D scanner. The subsequent manipulation step for repositioning the misaligned dental model is performed digitally with the aid of a suitable software program, after which, finally with the aid of a CAM procedure, for example using a 3-D printer or a milling machine, the setup with the repositioned tooth models is produced. Methods of this type are disclosed, for example, in the EP patent EP2263598 B1, the full contents of which are referenced here and the contents of which are included by reference in the disclosure content of the present application.

Alternatively this setup can also be produced using an alveolar ridge model as disclosed in WO2014096341 from the present applicant, the full contents of which are referenced here and the contents of which are included by reference in the disclosure content of the present application.

Alternatively this setup can also be produced using a typodont as disclosed in WO2014135599 A1 from the present applicant, the full contents of which are referenced here and the contents of which are included by reference in the disclosure content of the present application.

FIG. 2A shows the setup according to FIG. 1C with attachments 21, 22, 23 and an arch wire element 24 to be fastened to this attachment placed thereon. For example, the arch wire element consists of a wire with a rectangular cross section, which is introduced into correspondingly shaped bores or recesses of the attachments by press-fit. In this manner attachments and arch wire elements can transfer tilting and rotational moments relating to all six degrees of freedom to one another.

An advantageous aspect of this embodiment is that the attachments—unlike conventional attachments—need not have a front-opening lock and a corresponding ligature, since the arch wire element need not necessarily be inserted from the front into the attachment already fixed in place, but can be introduced from the side into the attachments or the bores provided therein. Alternatively to the embodiment shown in FIG. 2A, an already prefabricated combination of attachments with an arch wire element already introduced into them can also be affixed to teeth.

In FIG. 2B the arch wire element is shown in position on the attachments. In this configuration, which corresponds to the final state of the dental configuration—or a transition state thereof—the arch wire element is not tensioned.

FIG. 2C shows the combination 25 of attachments and arch wire element after releasing the attachment from the setup.

FIG. 3A shows how the non-stressed combination 25 of attachments and arch wire element is now brought into the reproduction 15 of the dental arch with misaligned teeth shown in FIG. 1B. This is done by affixing the attachments to the dental model. In this process the arch wire element is stressed, since the attachments are tilted or rotated relative to the wire arch element and in this way, tilting and rotational moments build up.

In a next step, which is shown in FIG. 3B, the combination 25 or attachments and arch wire element prestressed in this way is fixed using a transfer template 31 and removed in a stress-preserving manner from the dental models of the reproduction 15 of the dental arch with misaligned teeth.

In a next step, which is shown in FIG. 4A, the prestressed combination 25 of attachments and arch wire element is now brought with the aid of the transfer template 31 onto the dental arch of the patient with misaligned teeth shown in FIG. 1a. In this process the attachments are affixed to the teeth.

The combination 25 of attachments and arch wire element is prestressed, and the arch wire element has the tendency to return to its configuration shown in FIG. 2B. In this process, by means of the attachments it exerts tilting and rotational moments on the teeth to be corrected into their position and thus brings about a change in the configuration of the teeth to the final state of the dental configuration to that which is shown in FIG. 4C--or a transition state thereof

FIG. 5 shows a prestressed combination 51 of attachments and arch wire element produced with the method shown in FIGS. 1-4 which relates to only part of the jaw of a patient (“partial braces”). In the example shown, the position of one tooth 52 must be corrected considerably, whereas the positions of the other teeth do not need to be corrected, or only minimally corrected.

FIGS. 5A-5C show the incremental correction pathway that is followed by the tooth to be corrected based on the tilting and rotational moments exerted by the prestressed arch wire element.

FIG. 6 likewise shows a prestressed combination 61 of attachments and arch wire element produced with the method shown in FIGS. 1-4 which relates to only part of the jaw of a patient (“partial braces”). In the example shown, only the position of one tooth 62 must be corrected considerably. Additionally, in FIG. 6 a partial aligner 63 is shown, which has a recess in the area. of the combination 61 of attachments and arch wire element. The aligner serves to stabilize the additional teeth in the patient's jaw and optionally may also have a repositioning effect on individual teeth, the need for correction of which is less than with regard to tooth 62.

The aligner also serves for stabilizing the teeth surrounding the tooth 62 to be corrected, to which the combination 61 of attachments and arch wire element is fastened, and which serve as abutments for these teeth. In this way the aligner prevents the position of teeth surrounding the tooth 62 to be corrected from shifting.

FIGS. 6A-C show the incremental correction pathway that is followed by the tooth to be corrected based on the tilting and rotational moments exerted by the prestressed arch wire element. In this process the aligner may also consist of a series of incremental aligners, which have successive repositioning effects on additional teeth in the patient's jaw. Such incremental aligners are disclosed, for example, in the EP patent EP2263598 B1 and EP patent EP1369091 B1, the full contents of which are referenced here and the contents of which are included by reference in the disclosure content of the present application.

FIG. 7 likewise shows a combination 71 of attachments and arch wire element produced with the method shown in Figs, 1-4, which relates to only part of the jaw of a patient (“partial braces”). In the example shown, only the position of one tooth 72 must be corrected. Additionally, in FIG. 6 an aligner 73 is shown, which has a recess in the area of the combination 71 of attachments and arch wire element. The aligner serves to stabilize the additional teeth in the patient's jaw and optionally may also have a repositioning effect on individual teeth, wherein the need for correction is less than with regard to tooth 72.

The aligner also serves for stabilizing the teeth surrounding the tooth 72 to be corrected, to which the combination 71 of attachments and arch wire element is fastened, and which serve as abutments for these teeth. In this way the aligner prevents the position of teeth surrounding the tooth 62 to be corrected from shifting.

FIGS. 7A-C show the incremental correction pathway that is followed by the tooth to be corrected based on the tilting and rotational moments exerted by the prestressed arch wire element. In this process the aligner may also consist of a series of incremental aligners, which have successive repositioning effects on additional teeth in the patient's jaw. In this manner the volume of the expansion in the area of the tooth 72 decreases successively. Such incremental aligners are disclosed, for example, in the EP patent EP2263598 B1 and EP patent EP1369091 B1, the full contents of which are referenced here and the contents of which are included by reference in the disclosure content of the present application.

FIG. 8 shows that a combination 81 of attachments 82 and optionally prestressed arch wire elements 83 is also capable of extracting a tooth 84 from the jaw. A correction relating to this degree of freedom is difficult to accomplish with conventional aligners.

FIG. 9 shows a combination 91 of attachments 92 and arch wire elements 93, in which only two teeth 95 on one side of the tooth 94 to be corrected serve as abutments. In the extreme case only a single adjacent tooth may serve as an abutment. This embodiment is especially possible because the pretensioning represented symbolically by reference symbols 96 may also be able to eliminate the “sliding mechanics” that occur with conventional methods. Therefore in Fig, 9 the arch wire element can be solidly affixed on the attachments.

This configuration is optionally supported by the combination with a dental splint as described above. The latter makes it possible, by stabilizing the teeth that serve as abutments for the tooth to be corrected, to reduce the number of the said teeth serving as abutments.

### REFERENCES

E. E. Hemayed, S. M. Yamany, and A. A. Farag, 3D model building in computer vision with orthodontic applications, Technical Report TR-CVIP 96, CVIP Lab., University of Louisville, November 1996.
Biggerstaff R H. Computerized diagnostic setups and simulations. Angle Orthod. 1970 January,40(1):28-36.
Kuroda T I, Motohashi N, Tominaga. R, Iwata K. Three-dimensional dental cast analyzing system using laser scanning. Am J Orthod Dentofacial Orthop. 1996 October;110(4):365-9.

Ender A I, Mehl A. Influence of scanning strategies on the accuracy of digital intraoral scanning systems. Int J Comput Dent. 2013;16(1):11-21.

McNamara, Orthodontic and Orthopedic Treatment in the Mixed Dentition, Needham Pr (June 1993), page 347

1. A method for producing a prestressed (“pre-loaded”) tooth repositioning device, comprising:
a) Producing a real or digital model of a jaw or jaw section of a patient with at least one misaligned tooth (“actual condition”)
b) Producing a real or digital model of a jaw or jaw section of a patient in which the position of at least one tooth is changed in comparison to the model mentioned in step a) (“target condition”),
c) Digital or real positioning of a real or digital tooth repositioning device on the real or digital model mentioned in step b),
d) Transferring the real or digital tooth repositioning device according to step c) to the real or digital model with at least one misaligned tooth according to step a), with the real or digital tooth repositioning device being prestressed, and
e) Optionally producing a real prestressed tooth positioning device on the basis of the digital tooth repositioning device according to step d) by way of a CAM method.

2. The method according to claim 1, also comprising the following:
f) Transferring the real or digital prestressed tooth repositioning device with the aid of a stress-conserving transfer template to the jaw or jaw section of a patient with at least one misaligned tooth.

3. The method of claim 1, wherein the tooth repositioning device comprises at least one arch wire element and at least two attachments.

4. The method of claim 3, wherein the arch wire element consists of a wire with a polygonal cross section.

5. The method of claim 3, wherein at least one attachment comprises a polygonal bore or recess.

6. The method of claim 3, wherein at least one attachment comprises a ligature with a lock.

7. The method of claim 1, wherein the digital or real positioning of a real or digital tooth repositioning device takes place on the real or digital model mentioned in step b), wherein
at least two attachments are disposed on at least two teeth of the model and then an arch wire element is introduced into correspondingly shaped bores or recesses of the attachment, or
an already prefabricated combination of at least two attachments with an arch wire element already introduced into them is affixed to the at least two teeth.
in situ an attachment, having a bore or recess for the arch wire element, is produced on at least one tooth of the model, and then an arch wire element is introduced into correspondingly shaped bores or recesses of the attachment, or

8. The method of claim 1, wherein the real model of the jaw or jaw section with at least one misaligned tooth (“actual state”) is produced by taking an impression in dental impression compound and then casting the same with dental casting compound.

9. The method of claim 1, wherein the digital model of the jaw or jaw section with at least one misaligned tooth (“actual state”) is produced by a three-dimensional imaging method.

10. The method of claim 1, wherein the real model of the jaw or jaw section in which the position of at least one tooth has been modified (“target condition”) is produced by sawing off the said tooth and placing it on a socket of a deformable material, and then manually manipulating the position of the said tooth.

11. The method of claim 1, wherein the digital model of the jaw or jaw section in which the position of at least one tooth has been modified (“target condition”) is produced by digital manipulation of the image or data set representing the jaw or jaw section.

12. A prestressed tooth repositioning device, produced with the method of claim 1.

13. A prestressed tooth repositioning device according to claim 12, having at least two attachments and one arch wire element.

14. The use of a prestressed tooth repositioning device according to claim 12 for treating dental misalignment in patients.

15. A stress-conserving transfer template for transferring a prestressed tooth repositioning device to the jaw or jaw section of a patient with at least one misaligned tooth.

16. A kit for correcting dental misalignments, comprising
a) a combination of at least two attachments with an arch wire element already arranged therein, wherein the said combination is arranged in the area of a jaw section of a patient having at least one misaligned tooth (“actual state”) and
b) at least one dental splint made of a resilient material, wherein the said dental splint is arranged in at least one area of the patient's jaw section located outside of the area mentioned under a).

17. A kit for correcting dental misalignments, comprising
a) a combination of at least two attachments with an arch wire element already arranged therein, wherein the said combination is arranged in the area of a jaw section of a patient having at least one misaligned tooth (“actual state”) and
b) at least one dental splint made of a resilient material, wherein the said dental splint is arranged in at least one area of the patient's jaw section located outside of the area mentioned under a),
wherein the combination of at least two attachments and one wire arch element is produced with the method of claim 1.

18. The kit of claim 16, wherein the dental splint consisting of a resilient material is an aligner, retainer or positioner.

19. The kit of claim 16, wherein the at least one dental splint has a recess in the area of the combination of attachment and arch wire element.

20. The kit of claim 16, wherein at least one dental splint has an enlargement in the area of the combination of attachment and arch wire element.

21. The kit of claim 16, wherein the at least one dental splint in the area of at least one attachment has an enlargement in which the bracket may be received by press fit.

22. The kit of claim 16, wherein the said kit has several dental splints consisting of a resilient material, wherein at least
one dental splint has a geometry selected to support the repositioning of at least one misaligned tooth from the actual state into a transition state, accomplished by the combination of attachment and arch wire element,
and one dental splint has a geometry selected to support the repositioning of the at least one misaligned tooth from the transition state to a target state, accomplished by the combination of attachment and arch wire element.

23. The use of the kit of claim 16 for treating dental misalignment in patients.

24. The use according to claim 23, wherein for successive treatment of dental misalignment, several dental splints consisting of a resilient material, are used, wherein at least
one dental splint has a geometry selected to support the repositioning of at least one misaligned tooth from the actual state into a transition state, accomplished by the combination of attachment and arch wire element,
and one dental splint has a geometry selected to support the repositioning of the at least one misaligned tooth from the transition state to a target state, accomplished by the combination of attachment and arch wire element.
